(19) United States
(12) Patent Application Publication
(10) Pub. No.: US 2022/0414542 A1
(43) Pub. Date: Dec. 29, 2022

(54) On-The-Fly Feeding of Personalized or Domain-Specific Submodels

(71) Applicant: Google LLC, Mountain View, CA (US)

(72) Inventors: Fadi Biadsy, Sandyston, NJ (US); Katrin Ruth Sarah Tomanek, San Francisco, CA (US)

(21) Appl. No.: 17/851,712

(22) Filed: Jun. 28, 2022

Related U.S. Application Data
(60) Provisional application No. 63/215,710, filed on Jun. 28, 2021.

(51) Int. Cl. G06N 20/00; G06N 5/02

(52) U.S. Cl. CPC G06N 20/00; G06N 5/022

(57) ABSTRACT

The present disclosure relates generally to machine learning. More particularly, the present disclosure relates to on-the-fly feeding of personalized, domain-specific, context-specific, and/or task-specific submodels as input to an existing base model which has already been loaded into a memory (e.g., loaded into an existing session associated with execution of a machine learning library).

### RELATED APPLICATIONS

This application claims priority to and the benefit of U.S. Provisional Patent Application No. 63/215,710, filed Jun. 28, 2021. U.S. Provisional Patent Application No. 63/215,710 ais hereby incorporated by reference in its entirety.

### FIELD

The present disclosure relates generally to machine learning. More particularly, the present disclosure relates to on-the-fly feeding of personalized, domain-specific, context-specific, and/or task-specific submodels as input to an existing base model which has already been loaded into a memory (e.g., loaded into an existing session associated with execution of a machine learning library).

### BACKGROUND

Existing approaches to the use of machine-learned models typically include training a model as a single unit and then statically serving the model. In particular, an existing deployment pipeline for machine-learned models includes first training a model and then using it during inference, feeding it user inputs, and potentially other contextual signals. To provide one specific example, one may train a single Automatic Speech Recognition (ASR) model to serve many domains and users, given their geolocation features. This model is typically trained statically and then served statically for its whole lifetime. Approaches which build and serve a single static model for all different users, domains, contexts, or tasks are significantly inflexible.

Further, if additional flexibility to handle different users, domains, contexts, and/or tasks is required, existing approaches require the separate training and deployment of a different model for each different user, domain, context, and/or task. This introduces significant redundances at both training (e.g., training multiple completely different models) and inference/deployment (e.g., loading and unloading multiple models into memory to satisfy the current user, domain, context, and/or task). Such redundancies result in significant and redundant consumption of computing resources such as processor usage, memory usage, network bandwidth, etc.

### SUMMARY

Aspects and advantages of embodiments of the present disclosure will be set forth in part in the following description, or can be learned from the description, or can be learned through practice of the embodiments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computing system for more efficient use of computational resources to deploy machine learning across different users. The computing system includes one or more processors. The system also includes one or more non-transitory memories that store instructions that when executed by the one or more processors cause the computing system to perform operations. The operations may include initiating an execution session of a machine learning library, where initiation of the execution session may include loading a machine-learned base model into at least a first memory of the one or more non-transitory memories, and where the machine-learned base model may include a first set of learned parameter values. The operations may include operations after loading the machine-learned base model into at least the first memory of the one or more non-transitory memories and while the execution session of a machine learning library is ongoing. These operations may include receiving a model input associated with a particular user, domain, context, or task. These operations may include accessing a machine-learned submodel associated with the particular user, domain, context, or task, where the machine-learned submodel may include a second set of learned parameter values that have been learned from training data associated with the particular user, domain, context, or task. These operations may include dynamically generating, in the execution session, a combined machine-learned model, where the combined machine-learned model may include both the first set of learned parameter values and the second set of learned parameter values. These operations may include processing, in the execution session, the model input with the combined machine-learned model to generate a model output. Other embodiments of this aspect include corresponding computer systems, apparatus, and computer programs recorded on one or more computer storage devices, each configured to perform the actions of the methods.

Implementations may include one or more of the following features. The computing system of claim 1, where dynamically generating the combined machine-learned model that may include both the first set of learned parameter values and the second set of learned parameter values may include: dynamically combining the second set of learned parameter values into the machine-learned base model according to an existing execution graph associated with the machine-learned base model and the execution session, the execution graph describing a set of dataflow computations to execute the combined machine-learned model. Dynamically combining the second set of learned parameter values into the machine-learned base model according to the existing execution graph may include: inserting the second set of learned parameter values into the machine-learned base model at one or more locations within the machine-learned base model specified by the existing execution graph to generate the combined machine-learned model. The one or more locations within the machine-learned base model specified by the existing execution graph may include one or more hidden layers of the machine-learned base model that are distinct from and follow an initial input layer of the machine-learned base model. Dynamically generating the combined machine-learned model that may include both the first set of learned parameter values and the second set of learned parameter values may include: replacing one or more first learned parameter values included the first set of learned parameter values with one or more second learned parameter values included in the second set of learned parameter values. Dynamically generating the combined machine-learned model that may include both the first set of learned parameter values and the second set of learned parameter values may include: adding the second set of learned parameter values to the first set of learned parameter values. The computing system may consist of a server computing system. The machine-learned submodel may be associated with the particular user; and accessing the machine-learned submodel associated with the particular user may include receiving the machine-learned submodel from a user device associated with the particular user. Accessing the machine-learned submodel associated with the particular user, domain, context, or task may include: receiving an identifier associated with the particular user, domain, context, or task; and accessing a data repository storing a plurality of machine-learned submodels associated with a plurality of different users, domains, contexts, or tasks to identify and retrieve the machine-learned submodel associated with the particular user, domain, context, or task, where the machine-learned submodel associated with the particular user, domain, context, or task is logically associated with the identifier within the data repository. The data repository may be stored on a hard disk. The operations further may include, after loading the machine-learned base model into at least the first memory of the one or more non-transitory memories and while the execution session of the machine learning library is still ongoing: receiving a second model input associated with a second particular user, domain, context, or task; accessing a second machine-learned submodel associated with the second particular user, domain, context, or task, where the second machine-learned submodel may include a third set of learned parameter values that have been learned from training data associated with the second particular user, domain, context, or task; dynamically generating, in the execution session, a second combined machine-learned model, where the second combined machine-learned model may include both the first set of learned parameter values and the third set of learned parameter values, and where the second combined machine-learned model excludes the second set of learned parameter values; and processing, in the execution session, the second model input with the second combined machine-learned model to generate a second model output. The operations further may include, after loading the machine-learned base model into at least the first memory of the one or more non-transitory memories and while the execution session of the machine learning library is still ongoing: receiving a third model input unassociated with any particular user, domain, context, or task; and processing, in the execution session, the third model input with the machine-learned base model to generate a third model output, where processing, in the execution session, the third model input with the machine-learned base model may include applying an identity operation at one or more locations within the machine-learned base model specified by the existing execution graph as added submodel locations. The machine-learned submodel may be associated with the particular user; and accessing the machine-learned submodel associated with the particular user may include confirming that one or more authentication protocols have been satisfied as a condition of accessing the machine-learned submodel. The computing system may include of a mobile device or an embedded device. Implementations of the described techniques may include hardware, a method or process, or computer software on a computer-accessible medium.

One general aspect includes a computer-implemented method for training data access-efficient submodels. The computer-implemented method includes initiating, by a computing system may include one or more computing devices, an execution session of a machine learning library, where initiation of the execution session may include loading a base model into at least a first memory of the one or more non-transitory memories, and where the base model may include a first set of learned parameter values for a first set of parameters. The method also includes operations after loading the base model into at least the first memory of the one or more non-transitory memories and while the execution session of a machine learning library is ongoing. The method also includes accessing, by the computing system, a submodel associated with a particular user, domain, context, or task, where the submodel may include a second set of parameters. The method also includes dynamically generating, by the computing system and in the execution session, a combined model, where the combined model may include both the first set of parameters and the second set of parameters. The method also includes performing one or more training iterations. Each training iteration can include receiving a training input associated with the particular user, domain, context, or task. Each training iteration can include processing, in the execution session, the training input with the combined model to generate a training output. Each training iteration can include evaluating a loss function based on the training output. Each training iteration can include includes learning one or more of the second set of parameters of the submodel based on the loss function while holding the first set of parameters of the base model fixed. The method also includes separately storing the first set of parameters of the base model and the second set of parameters of the submodel. Other embodiments of this aspect include corresponding computer systems, apparatus, and computer programs recorded on one or more computer storage devices, each configured to perform the actions of the methods.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example computing environment according to example embodiments of the present disclosure.

FIGS. 2A-D depict example approaches for combining a submodel and a base model to generate a combined model according to example embodiments of the present disclosure.

FIGS. 3A-B depict an example two-stage approach to train a base model and a submodel according to example embodiments of the present disclosure.

FIGS. 4A-D depict example arrangements of devices within a computing system according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to on-the-fly feeding of personalized, domain-specific, context-specific, and/or task-specific submodels as input to an existing base model which has already been loaded into a memory (e.g., loaded into an existing session associated with execution of a machine learning library).

In particular, the present disclosure provides a novel approach to serve dynamic models during prediction. A dynamic model can include a model that takes part of its model parameters (e.g., weights, tensors, scaling factors, residual connection values, embedding inputs of contextual signals, etc.) as one of its inputs or otherwise inserts or adds the additional model parameters into an existing set of parameters during runtime. This set of additional model parameters added or inserted at runtime can be referred to as a submodel of the general model. In other words, during inference, a dynamic model can take a submodel as its input in addition typical inputs or can otherwise have the submodel inserted into or added with an existing base model.

More particularly, the dynamic models described herein can include two or more component parts or models including a general base model and a “swappable” submodel. The general base model can typically be trained on a variety of conditions, domains, and tasks. For example, a general ASR model trained on all sort of speech data for a given language. The responsibility of the base model is to typically cover the general distribution of the data.

The submodel can take various forms. In one example, the submodel can be a subset of the parameters that is inserted into or replaced existing parameters of the general base model (e.g., a full layer, individual tensors). The subset can be at various locations within the general model including input layers, hidden layers, output layers, and/or other parameters within the base model. Alternatively or additionally, the submodel can be an extra set of new parameters that is added or connected to the base model.

A number of different submodels can each be trained and fine-tuned on data relating to different users, tasks, domains, and/or contexts. As one example, a submodel can be trained on data associated with a particular speaker or domain. After training, any one or more of the submodels can combined (e.g., inserted into, added with, etc.) with the base model to form a combined model that provides superior performance as relates to the particular user, task, domain, and/or context for which the submodel has been trained.

In particular, in some implementations, training can occur as follows: In a first phase the base model can be trained on general training data to cover the general distribution for a given general population, task, etc. (e.g., ASR). In a second, subsequent phase, training data for a particular user, task, domain, and/or context (e.g., speaker) can be used to train the submodel. Specifically, in some implementations, only the parameters in the submodel can be learned while all other parameters of the base model are held fixed (so that the base model stays unchanged).

Note that if a set of parameters are shared between the submodel and base model, these parameters can be copied. Therefore, some example approaches do not alter the base model whatsoever.

After the base model and one or more submodels have been trained, the base model and one or more submodels can be combined to perform inference. Specifically, inference can include two general scenarios. In a first scenario, the computing system does not have any specific knowledge of any user, task, domain, or context (e.g., speaker, condition). In this scenario, the computing system can use the base model as is (e.g., without modification). Since the base model is typically not changed (and therefore covers the original general distribution), the base model will act as the general model to model the overall general distribution (e.g., general ASR engine).

However, in a second scenario, the computing system may have knowledge of or been instructed to make predictions for, on behalf of, or in view of a particular user, domain, context, or task. As one example, a computing system may be supplied with information indicating that the request is to serve a specific speaker with impaired speech where we already have a personalize model for them. Thus, in the second scenario, the computing system can fetch the submodel that correspond to the on-the-fly particular user, domain, context, or task (e.g., from disk). The computing system can replace and/or add the corresponding parameters (e.g., tensors, factors, etc.) on-the-fly dynamically and run inference within the same machine learning library execution session. As one example, the computing system can load the parameters of the submodel on-the-fly and add them to the base model.

Thus, in some implementations, the large base model is already loaded in volatile memory (e.g., RAM), so the computing system only needs to feed the submodel to it. This makes the proposed approach fast to load and therefore highly scalable.

The dynamic loading of submodels as described herein provides a number of technical effects and benefits. As one example, the submodel can be loaded from disk or LRU cache with low latency. This enables negligible loading time for a user/domain/use-case specific model, allowing for superior user, task, domain, or context-specific performance without the computational overhead of generating, training, loading, and running many different models. The techniques described herein also allows for on-the-fly/dynamic switching of models, which is scalable to a large number of users/models.

Furthermore, the submodels described herein can also be faster to train versus generating, training, loading, and running many different models which are each solely dedicated to a single user, task, domain, and/or context. For example, by training only the smaller number of parameters included in the submodel, the computing system is able to perform a reduced number of updates and gradient computations.

One example task where the proposed approaches are effective is ASR model personalization, especially when running those models on backend services. In this case, a submodel can be a small set of parameters tuned for a particular speaker fed into a general ASR model that takes speaker submodels as additional input.

More particularly, a model personalized for a specific speaker (e.g., ASR as well as other approaches to speech conversion) typically delivers best quality for that speaker. It is important to note that personalized models in general are prohibitively expensive to serve for inference on the server, due to the need to load a very large model per request per user. As a result, as the number of users is increased this approach clearly does not scale; To scale for a large number of users, all large models cannot be kept loaded on RAM.

Personalization is particularly important for cases where the specific speaker speech patterns diverge vastly from the average population. Speakers with heavily accented speech, regional dialects, atypical speech and speech impairments are good examples where personalized models may significantly improve their model quality. Thus, the systems and methods described herein can enable the use of personalized models on-the-fly—enabling scalable personalization with improved model performance.

Although ASR or speech conversion is provided as an example use case, the systems and methods of the present disclosure are not limited to this example. This approach can generalize far beyond speech models (e.g., domain specific domains for machine translation, object classification for self-driving cars specific for weather conditions, and/or any other combination of user, domain, context, and/or task).

Thus, the present disclosure provides a framework that allows flexible and dynamic models that can accommodate (learn, load, predict, and serve) any number of submodels loaded on-the-fly. The proposed approach enables the following technical effects and benefits. As one example, the present disclosure provides the flexibility to refresh over time only submodels for a particular use case (e.g. speaker, domain, task, context, etc.). This enables life-long learning. Another technical benefit is the flexibility to quickly adapt/train and then serve new submodels for future use cases. Another technical effect is that the submodel can be small enough that can be loaded on-the-fly per request from a fast storage (e.g., SSD) All these benefits are possible without changing/touching the general base model.

With reference now to the Figures, example embodiments of the present disclosure will be discussed in further detail.

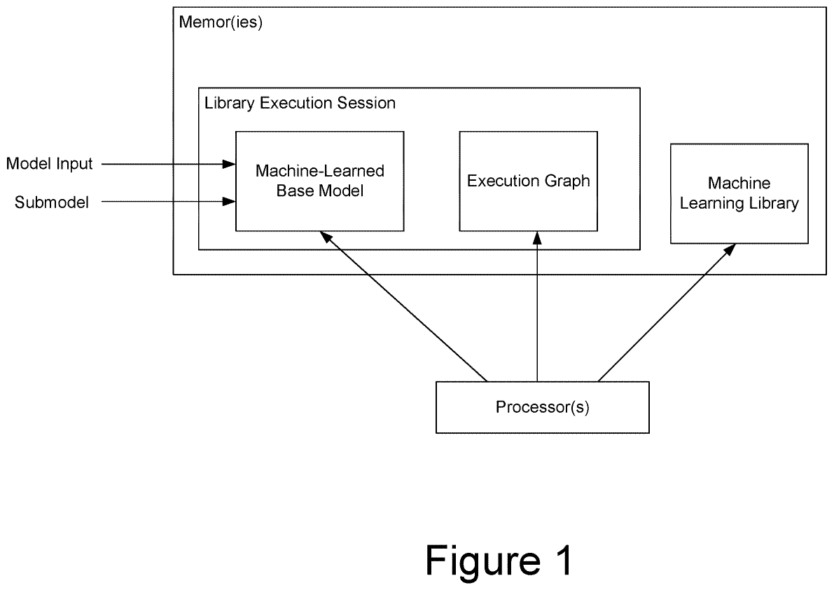

FIG. 1 depicts an example computing environment for more efficient use of computational resources to deploy machine learning across different users, domains, context, or tasks according to example embodiments of the present disclosure. The example computing environment can include one or more processors and one or more non-transitory memories that store instructions that when executed by the one or more processors cause the computing system to perform operations. The operations can include initiating an execution session of a machine learning library. One example machine learning library is TensorFlow. Initiation of the execution session can include loading a machine-learned base model into at least a first memory of the one or more non-transitory memories. The machine-learned base model can include a first set of learned parameter values.

After loading the machine-learned base model into at least the first memory of the one or more non-transitory memories and while the execution session of a machine learning library is ongoing, the computing system can perform on-the-fly feeding of personalized, domain-specific, context-specific, and/or task-specific submodel(s) as input to the existing base model.

Specifically, the computing system can receive a model input associated with a particular user, domain, context, or task. The computing system can also access (e.g., obtain, retrieve, or receive) a machine-learned submodel associated with the particular user, domain, context, or task. The machine-learned submodel can include a second set of learned parameter values that have been learned from training data associated with the particular user, domain, context, or task.

The computing system can dynamically generate, in the execution session, a combined machine-learned model. The combined machine-learned model can include both the first set of learned parameter values and the second set of learned parameter values. The computing system can process, in the execution session, the model input with the combined machine-learned model to generate a model output.

As one example, dynamically generating the combined machine-learned model that includes both the first set of learned parameter values and the second set of learned parameter values can include dynamically combining the second set of learned parameter values into the machine-learned base model according to an existing execution graph associated with the machine-learned base model and the execution session. The execution graph can describe a set of dataflow computations to execute the combined machine-learned model.

In some implementations, dynamically combining the second set of learned parameter values into the machine-learned base model according to the existing execution graph can include inserting the second set of learned parameter values into the machine-learned base model at one or more locations within the machine-learned base model specified by the existing execution graph to generate the combined machine-learned model. As examples, the one or more locations within the machine-learned base model specified by the existing execution graph can include one or more hidden layers of the machine-learned base model that are distinct from and follow an initial input layer of the machine-learned base model. As one example, the one or more locations can include a set of residual adapter layers.

Alternatively or additionally, dynamically generating the combined machine-learned model that includes both the first set of learned parameter values and the second set of learned parameter values can include replacing one or more first learned parameter values included the first set of learned parameter values with one or more second learned parameter values included in the second set of learned parameter values.

Alternatively or additionally, dynamically generating the combined machine-learned model that comprises both the first set of learned parameter values and the second set of learned parameter values can include adding the second set of learned parameter values to the first set of learned parameter values.

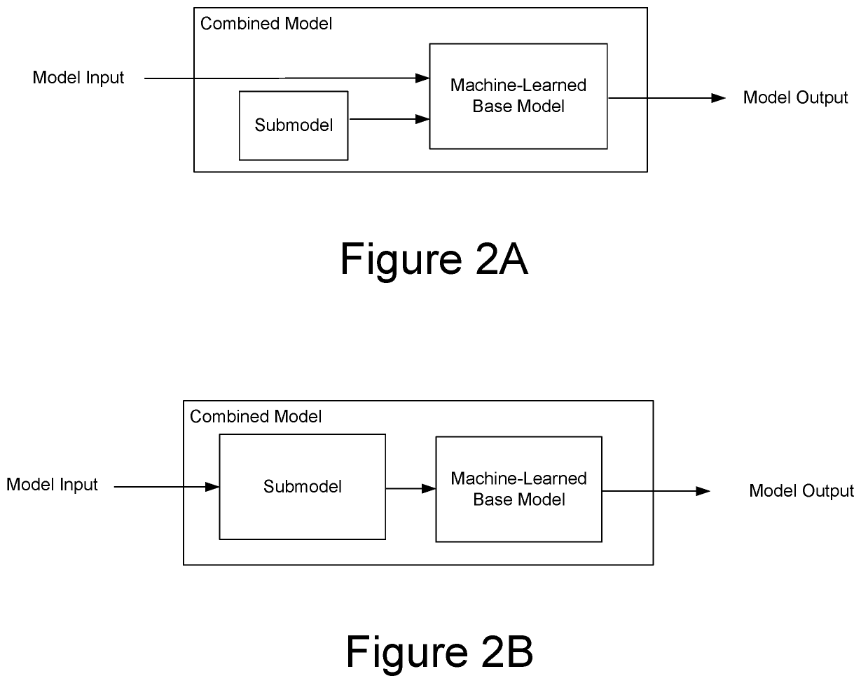

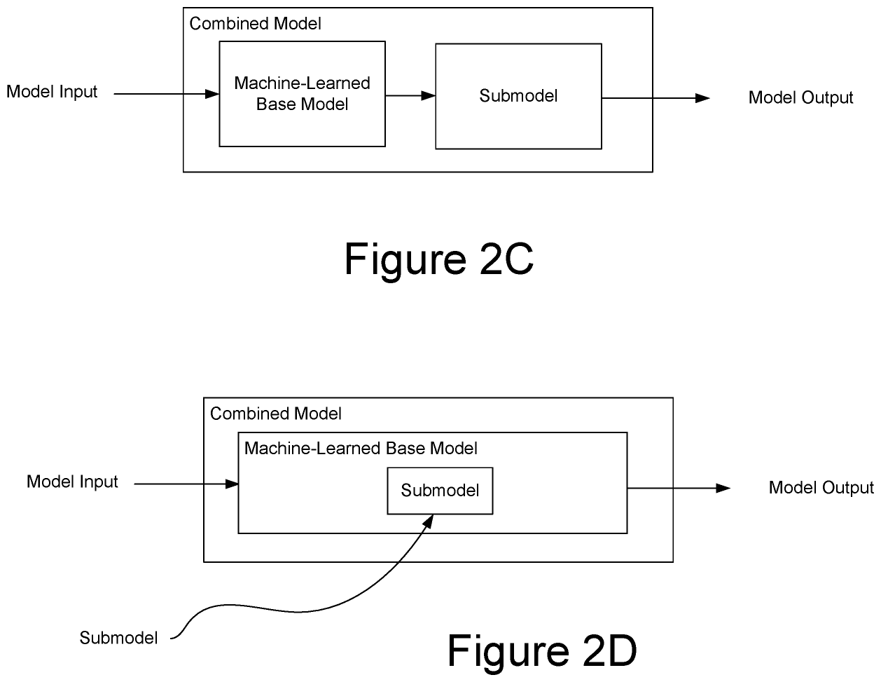

More particularly, FIGS. 2A-D depict example approaches for combining a submodel and a base model to generate a combined model according to example embodiments of the present disclosure.

As one example, as shown in FIG. 2A, the submodel parameters can be provided as input to an input layer of the base model. The model input can also be provided as input to an input layer of the base model alongside the submodel parameters.

As another example, as shown in FIG. 2B, the submodel can be placed prior to the base model in a data flow. The submodel can process the model input to generate an intermediate output and the base model can process the intermediate output to generate the model output.

As another example, as shown in FIG. 2C, the submodel can be placed subsequent to the base model in a data flow. The base model can process the model input to generate an intermediate output and the submodel can process the intermediate output to generate the model output.

As another example, as shown in FIG. 2D, the submodel can be inserted into the base model at an intermediate or hidden location. As one example, the submodel can be inserted as one or more additional and/or replacement hidden layers. As one example, the submodel can be a set of residual adapter layers.

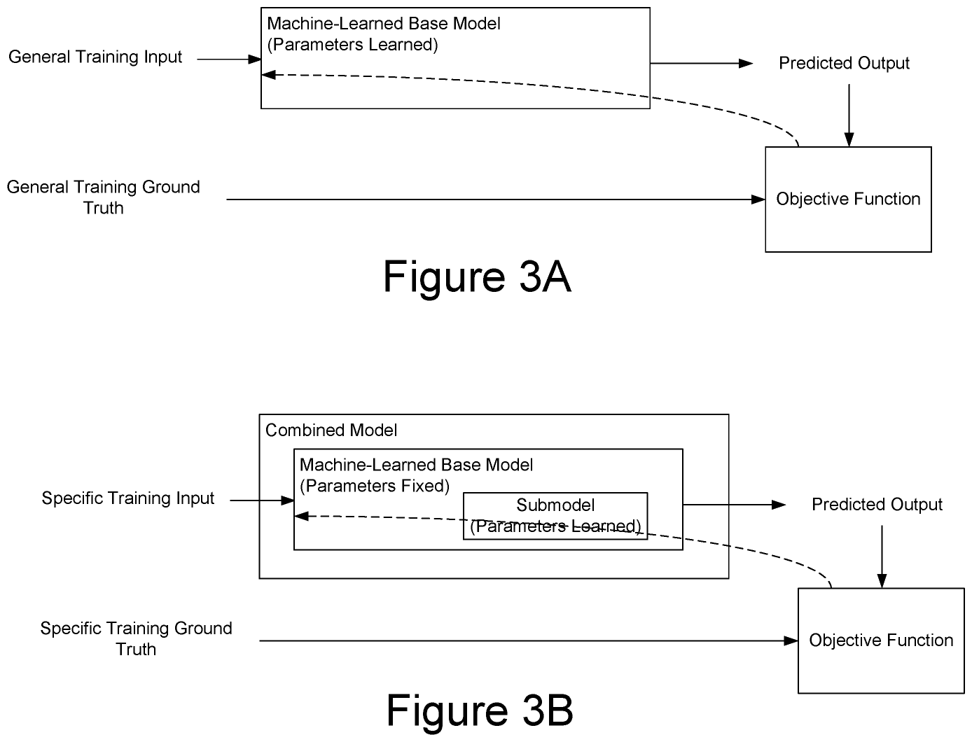

FIGS. 3A-B depict an example two-stage approach to train a base model and a submodel according to example embodiments of the present disclosure. In particular, in a first phase shown in FIG. 3A, the base model can be trained on general training data to cover the general distribution for a given general population, task, etc. In a second, subsequent phase shown in FIG. 3B, training data for a particular user, task, domain, and/or context (e.g., speaker) can be used to train the submodel. Specifically, in some implementations, only the parameters in the submodel can be learned while all other parameters of the base model are held fixed (so that the base model stays unchanged).

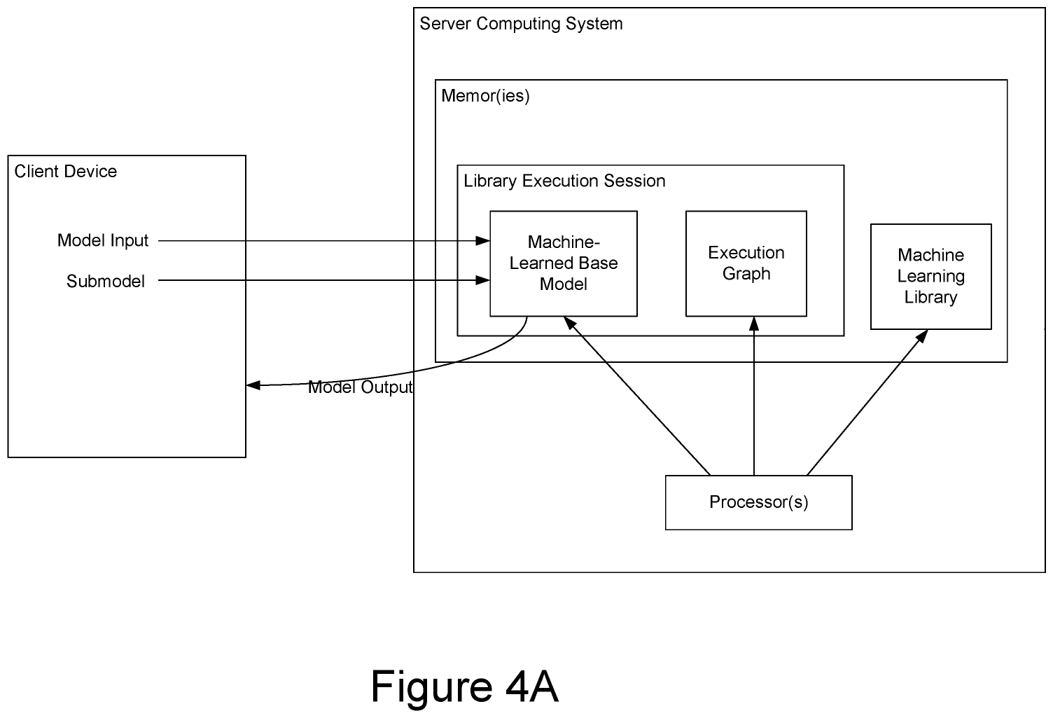

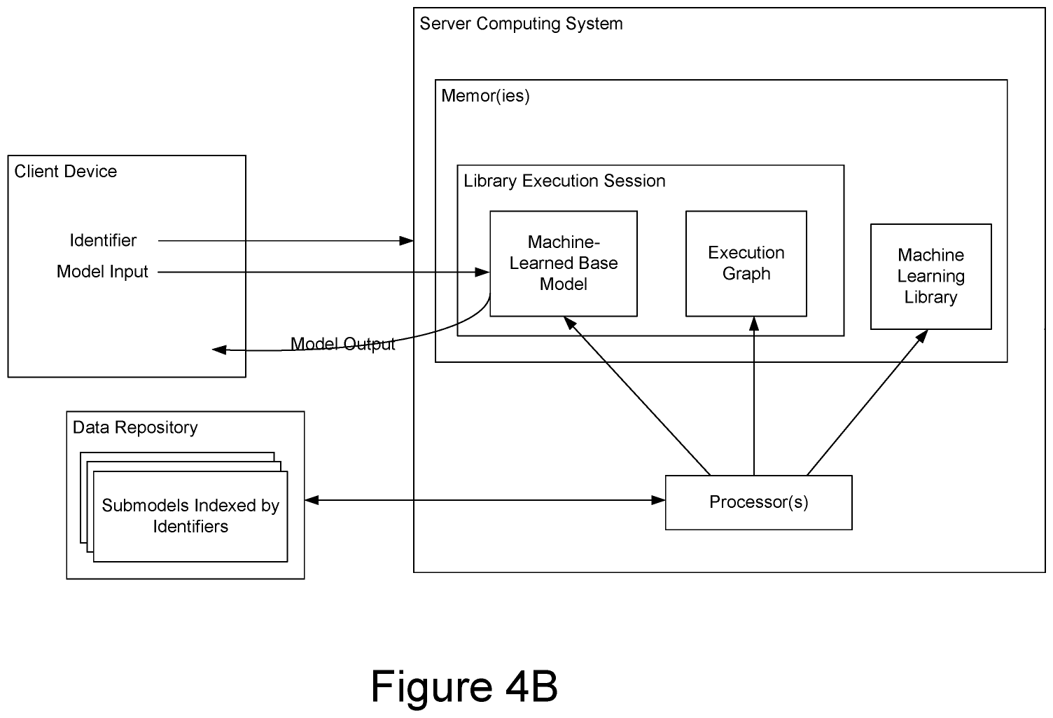

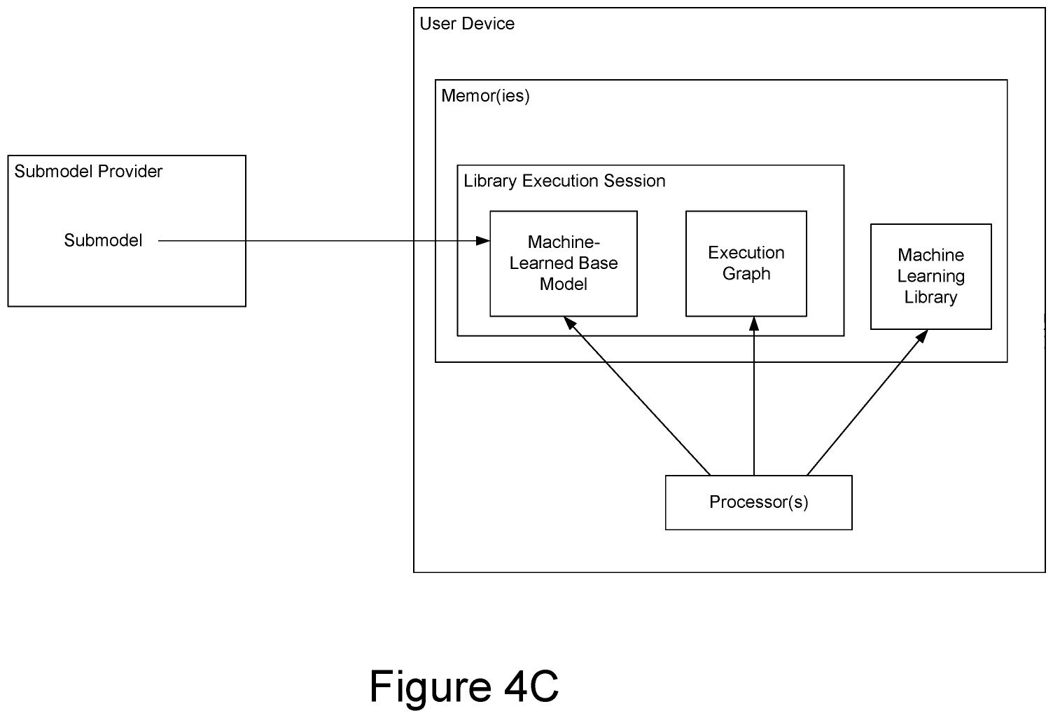

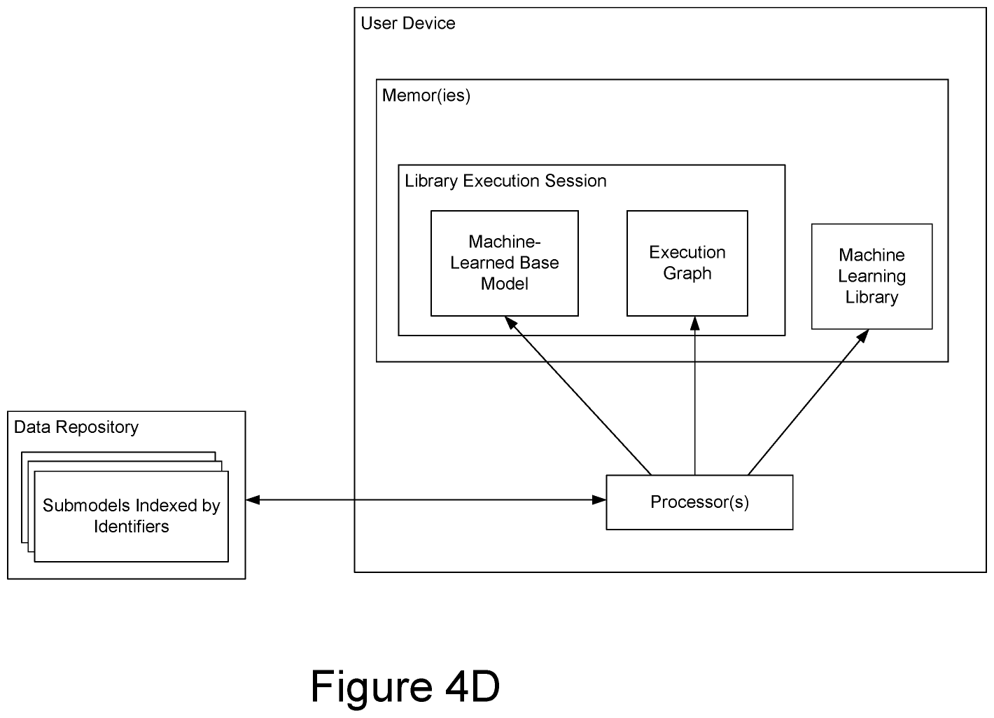

FIGS. 4A-D depict example arrangements of devices within a computing system according to example embodiments of the present disclosure.

As one example, as shown in FIG. 4A, a server computing system can implement the execution session including the base model. The server computing system can receive the model input and/or the submodel from a client computing device and perform the on-the-fly dynamic model generation process to produce the model output, which can then be returned to the client device. In some implementations, prior to performing the dynamic modeling, the server computing device can confirm that one or more authentication protocols associated with the submodel have been satisfied.

As another example, as shown in FIG. 4B, the server computing system can implement the execution session including the base model. The server computing system can receive the model input and/or an identifier from the client device. The server computing system can access a data repository storing a plurality of machine-learned submodels associated with a plurality of different users, domains, contexts, or tasks to identify and retrieve the machine-learned submodel associated with the particular user, domain, context, or task. In particular, the machine-learned submodel associated with the particular user, domain, context, or task can be logically associated with the identifier within the data repository. The repository can be an external database or an internal repository such as a disk drive. In some implementations, prior to performing the dynamic modeling, the server computing device can confirm that one or more authentication protocols associated with the submodel have been satisfied.

As another example, as shown in FIG. 4C, a user computing device can implement the execution session including the base model. The user computing device can receive the submodel from submodel provider and perform the on-the-fly dynamic model generation process to produce the model output. In some implementations, prior to performing the dynamic modeling, the user computing device can confirm that one or more authentication protocols associated with the submodel have been satisfied.

The submodel provider can be an external device or can be an internal repository associated with (e.g., included within) the user device. For example the user device can access the submodel from a local disk drive. As another similar example, as shown in FIG. 4D, the user computing device can access the submodel from a data repository (e.g., on the basis of or using a particular identifier).

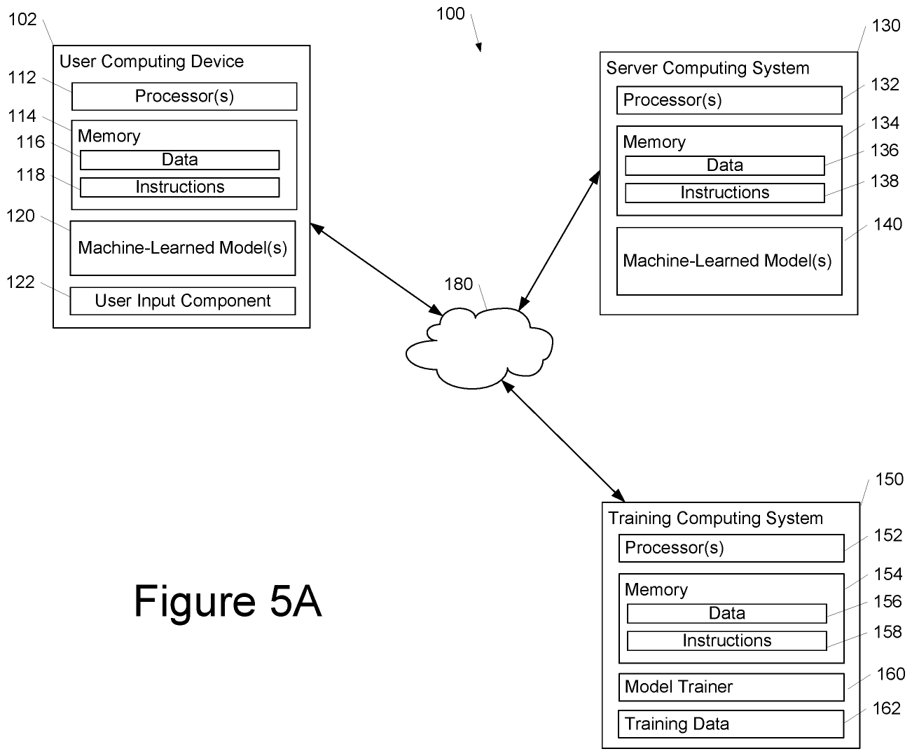

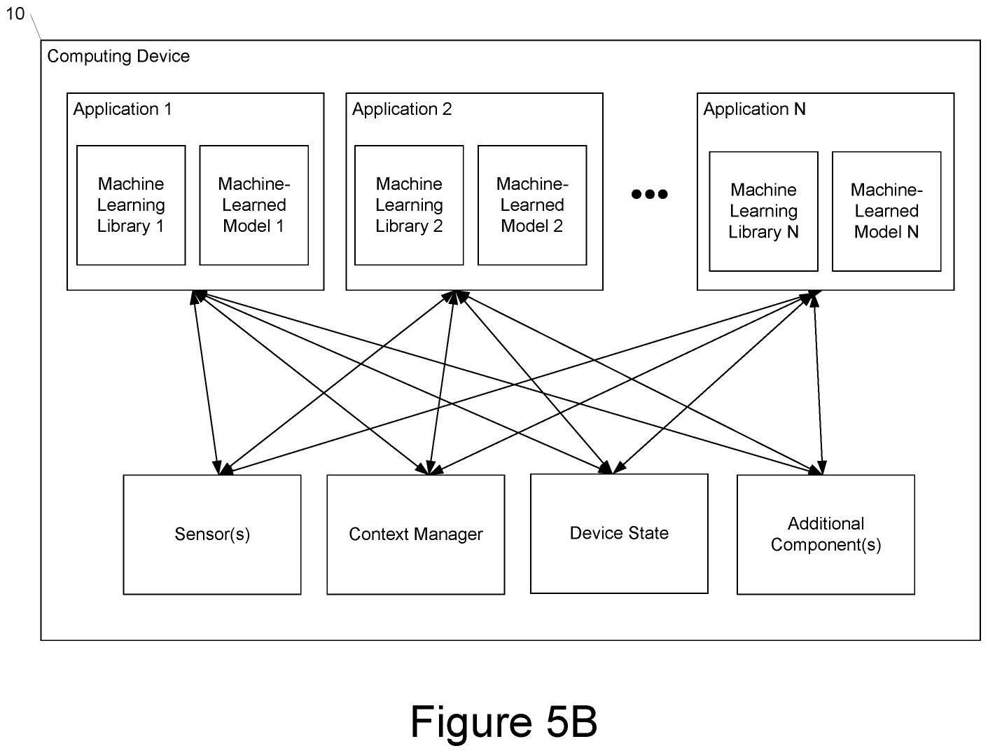

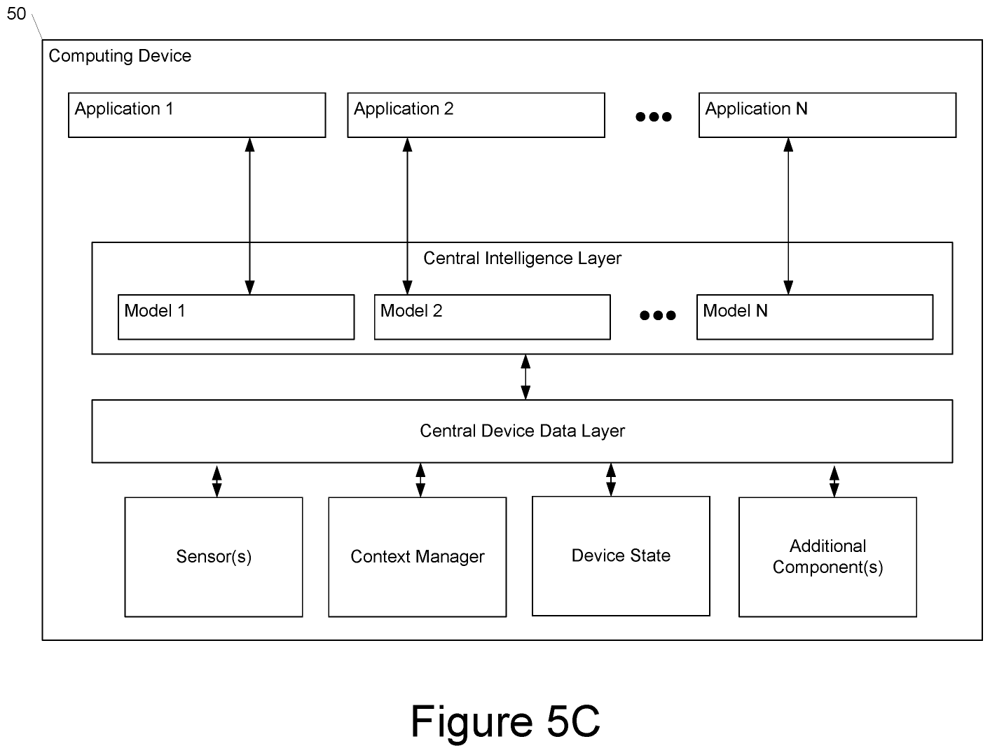

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-4D.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel inference across multiple instances of a base model).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service. Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-4D.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, both general training data and also specific training data that is specific to a particular user, task, context, and/or domain.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for more efficient use of computational resources to deploy machine learning across different users, domains, context, or tasks, the computing system comprising:
one or more processors; and
one or more non-transitory memories that store instructions that when executed by the one or more processors cause the computing system to perform operations, the operations comprising:
initiating an execution session of a machine learning library, wherein initiation of the execution session comprises loading a machine-learned base model into at least a first memory of the one or more non-transitory memories, and wherein the machine-learned base model comprises a first set of learned parameter values; and
after loading the machine-learned base model into at least the first memory of the one or more non-transitory memories and while the execution session of a machine learning library is ongoing:
receiving a model input associated with a particular user, domain, context, or task;
accessing a machine-learned submodel associated with the particular user, domain, context, or task, wherein the machine-learned submodel comprises a second set of learned parameter values that have been learned from training data associated with the particular user, domain, context, or task;
dynamically generating, in the execution session, a combined machine-learned model, wherein the combined machine-learned model comprises both the first set of learned parameter values and the second set of learned parameter values; and
processing, in the execution session, the model input with the combined machine-learned model to generate a model output.

2. The computing system of claim 1, wherein dynamically generating the combined machine-learned model that comprises both the first set of learned parameter values and the second set of learned parameter values comprises:
dynamically combining the second set of learned parameter values into the machine-learned base model according to an existing execution graph associated with the machine-learned base model and the execution session, the execution graph describing a set of dataflow computations to execute the combined machine-learned model.

3. The computing system of claim 2, wherein dynamically combining the second set of learned parameter values into the machine-learned base model according to the existing execution graph comprises:
inserting the second set of learned parameter values into the machine-learned base model at one or more locations within the machine-learned base model specified by the existing execution graph to generate the combined machine-learned model.

4. The computing system of claim 3, wherein the one or more locations within the machine-learned base model specified by the existing execution graph comprises one or more hidden layers of the machine-learned base model that are distinct from and follow an initial input layer of the machine-learned base model.

5. The computing system of claim 1, wherein dynamically generating the combined machine-learned model that comprises both the first set of learned parameter values and the second set of learned parameter values comprises:
replacing one or more first learned parameter values included the first set of learned parameter values with one or more second learned parameter values included in the second set of learned parameter values.

6. The computing system of claim 1, wherein dynamically generating the combined machine-learned model that comprises both the first set of learned parameter values and the second set of learned parameter values comprises:
adding the second set of learned parameter values to the first set of learned parameter values.

7. The computing system of claim 1, wherein the computing system consists of a server computing system.

8. The computing system of claim 7, wherein:
the machine-learned submodel is associated with the particular user; and
accessing the machine-learned submodel associated with the particular user comprises receiving the machine-learned submodel from a user device associated with the particular user.

9. The computing system of claim 7, wherein:
the machine-learned submodel is associated with the particular user; and
accessing the machine-learned submodel associated with the particular user comprises confirming that one or more authentication protocols have been satisfied as a condition of accessing the machine-learned submodel.

10. The computing system of claim 1, wherein the computing system consists of a mobile device or an embedded device.

11. The computing system of claim 1, wherein accessing the machine-learned submodel associated with the particular user, domain, context, or task comprises:
receiving an identifier associated with the particular user, domain, context, or task; and
accessing a data repository storing a plurality of machine-learned submodels associated with a plurality of different users, domains, contexts, or tasks to identify and retrieve the machine-learned submodel associated with the particular user, domain, context, or task, wherein the machine-learned submodel associated with the particular user, domain, context, or task is logically associated with the identifier within the data repository.

12. The computing system of claim 11, wherein the data repository is stored on a hard disk.

13. The computing system of claim 1, wherein the operations further comprise, after loading the machine-learned base model into at least the first memory of the one or more non-transitory memories and while the execution session of the machine learning library is still ongoing:
receiving a second model input associated with a second particular user, domain, context, or task;
accessing a second machine-learned submodel associated with the second particular user, domain, context, or task, wherein the second machine-learned submodel comprises a third set of learned parameter values that have been learned from training data associated with the second particular user, domain, context, or task;
dynamically generating, in the execution session, a second combined machine-learned model, wherein the second combined machine-learned model comprises both the first set of learned parameter values and the third set of learned parameter values, and wherein the second combined machine-learned model excludes the second set of learned parameter values; and
processing, in the execution session, the second model input with the second combined machine-learned model to generate a second model output.

14. The computing system of claim 1, wherein the operations further comprise, after loading the machine-learned base model into at least the first memory of the one or more non-transitory memories and while the execution session of the machine learning library is still ongoing:
receiving a third model input unassociated with any particular user, domain, context, or task; and
processing, in the execution session, the third model input with the machine-learned base model to generate a third model output, wherein processing, in the execution session, the third model input with the machine-learned base model comprises applying an identity operation at one or more locations within the machine-learned base model specified by the existing execution graph as added submodel locations.

15. A computer-implemented method for training data access-efficient submodels, the method comprising:
initiating, by a computing system comprising one or more computing devices, an execution session of a machine learning library, wherein initiation of the execution session comprises loading a base model into at least a first memory of the one or more non-transitory memories, and wherein the base model comprises a first set of learned parameter values for a first set of parameters; and
after loading the base model into at least the first memory of the one or more non-transitory memories and while the execution session of a machine learning library is ongoing:
accessing, by the computing system, a submodel associated with a particular user, domain, context, or task, wherein the submodel comprises a second set of parameters;
dynamically generating, by the computing system and in the execution session, a combined model, wherein the combined model comprises both the first set of parameters and the second set of parameters; and
for each of one or more training iterations:
receiving a training input associated with the particular user, domain, context, or task;
processing, in the execution session, the training input with the combined model to generate a training output;
evaluating a loss function based on the training output; and
learning one or more of the second set of parameters of the submodel based on the loss function while holding the first set of parameters of the base model fixed; and
separately storing the first set of parameters of the base model and the second set of parameters of the submodel.

16. One or more non-transitory memories that store instructions that when executed by one or more processors cause a computing system to perform operations, the operations comprising:
initiating an execution session of a machine learning library, wherein initiation of the execution session comprises loading a machine-learned base model into at least a first memory of the one or more non-transitory memories, and wherein the machine-learned base model comprises a first set of learned parameter values; and
after loading the machine-learned base model into at least the first memory of the one or more non-transitory memories and while the execution session of a machine learning library is ongoing:
receiving a model input associated with a particular user, domain, context, or task;
accessing a machine-learned submodel associated with the particular user, domain, context, or task, wherein the machine-learned submodel comprises a second set of learned parameter values that have been learned from training data associated with the particular user, domain, context, or task;
dynamically generating, in the execution session, a combined machine-learned model, wherein the combined machine-learned model comprises both the first set of learned parameter values and the second set of learned parameter values; and
processing, in the execution session, the model input with the combined machine-learned model to generate a model output.

17. The one or more non-transitory memories of claim 16, wherein dynamically generating the combined machine-learned model that comprises both the first set of learned parameter values and the second set of learned parameter values comprises:
dynamically combining the second set of learned parameter values into the machine-learned base model according to an existing execution graph associated with the machine-learned base model and the execution session, the execution graph describing a set of dataflow computations to execute the combined machine-learned model.

18. The one or more non-transitory memories of claim 17, wherein dynamically combining the second set of learned parameter values into the machine-learned base model according to the existing execution graph comprises:
inserting the second set of learned parameter values into the machine-learned base model at one or more locations within the machine-learned base model specified by the existing execution graph to generate the combined machine-learned model.

19. The one or more non-transitory memories of claim 18, wherein the one or more locations within the machine-learned base model specified by the existing execution graph comprises one or more hidden layers of the machine-learned base model that are distinct from and follow an initial input layer of the machine-learned base model.

20. The one or more non-transitory memories of claim 16, wherein dynamically generating the combined machine-learned model that comprises both the first set of learned parameter values and the second set of learned parameter values comprises:
replacing one or more first learned parameter values included the first set of learned parameter values with one or more second learned parameter values included in the second set of learned parameter values.
